(19) United States
(12) Patent Application Publication
(10) Pub. No.: US 2026/0079430 A1
(43) Pub. Date: Mar. 19, 2026

(54) HEATING DEVICE AND IMAGE FORMING APPARATUS

(71) Applicant: CANON KABUSHIKI KAISHA, Tokyo (JP)

(72) Inventors: MASATOSHI ITOH, Shizuoka (JP); HIROMITSU KUMADA, Shizuoka (JP); YASUMASA MATAYOSHI, Shizuoka (JP)

(21) Appl. No.: 19/297,212

(22) Filed: Aug. 12, 2025

(30) Foreign Application Priority Data
Sep. 17, 2024 (JP) 2024-160111
Mar. 27, 2025 (JP) 2025-053549

(51) Int. Cl. G03G 15/20; G03G 15/00

(52) U.S. Cl. CPC G03G 15/2039; G03G 15/5004; G03G 15/80; G03G 2215/00978

(57) ABSTRACT

A heating device includes a heater, a switching element connected between the heater and an AC power, and a controller performing a wave number control. A power control pattern includes a first pattern of which a control period is a first number, equal to or more than 2, of half waves and which satisfies a positive/negative symmetry, and a second pattern of which the control period is a second number, equal to or more than 2 and divisible by 4, of half waves and which satisfies the positive/negative symmetry. The controller sets the second pattern in a case where a supplying power duty is a first duty and sets the first pattern in a case where the supplying power duty is a second duty which is the supplying power duty larger or smaller by one step than the first duty, and performs wave number control.

### BACKGROUND

### Field of the Technology

The present invention relates to a heating device and an image forming apparatus and, for example, a control method for a fixing heater in the image forming apparatus using an electrophotographic process.

### Description of the Related Art

A conventional image heating device (hereinafter, referred to as a fixing device) in an image forming apparatus using an electrophotographic process fixes an unfixed image (toner image) formed on a transfer paper by an image forming means such as an electrophotographic process onto the transfer paper. Examples of the fixing device include a heat fixing device of a heated roller type with a halogen heater as a heat source and the heat fixing device of a film heating type with a ceramic surface heater as a heat source, etc. Generally, heaters are connected to an AC power source via a switching element such as a triac, and power is supplied by the triac being controlled. In heater control with the triac, as in Japanese Patent Application Laid-Open No. 2002-050450, for example, wave number control in which the triac is turned on and off near a zero-cross point of an AC voltage is performed. By this, a power supply control method which reduces noise upon turning on a current flowing through a heater with low harmonic current is proposed. By employing the wave number control as the power supply control method for the heater, noise is reduced, thus filters can be simplified and a size of the device can be reduced.

In recent years, the image forming apparatus is becoming faster. In such a high-speed image forming apparatus, more power becomes required to heat and fix the toner image formed on a sheet. In order to supply more power to the heater to heat and fix the toner image, it is necessary to reduce a resistance value of the heater. In a case of reducing the resistance value of the heater in the wave number control, a problem that flicker worsens arises. Therefore, even in the case of reducing the resistance value of the heater, it is needed to improve the flicker, which becomes the problem in the wave number control, and to increase suppliable power.

The present invention is conceived under such a background, and an object of the present invention is to improve flicker in wave number control even in a case of reducing a resistance value of a heater in order to increase suppliable power.

### SUMMARY

In order to solve the aforementioned problems, the present invention includes the following configuration.

(1) A heating device comprising: a heat generating member connected to an AC power source; a switching element connected between the AC power source and the heat generating member, and configured to be switched between a conductive state in which a power of the AC power source is allowed to be supplied to the heat generating member and a non-conductive state in which the power of the AC power source is not allowed to be supplied to the heat generating member; a control means configured to perform a wave number control in which the power supplied to the heat generating member is controlled by switching the switching element to the conductive state or the non-conductive state for each half wave with a plurality of continuous half waves as a control period in a waveform of an AC voltage of the AC power source; and a detecting means configured to detect a temperature of the heat generating member, wherein the control means determines a supplying power duty which is a ratio of the power suppled to the heat generating member in the control period based on the temperature of the heat generating member detected by the detecting means and a target temperature of the heat generating member, sets a power control patten defining presence/absence of a power supply in each half wave within the control period based on the supplying power duty which is determined, and performs the wave number control in response to the power control pattern which is set, wherein when a relationship in which a number of positive half waves in which the switching element becomes the conductive state in the control period and a number of negative half waves in which the switching element becomes the conductive state in the control period become the same number is defined as a positive/negative symmetry, the power control pattern includes a first pattern of which the control period is a first number, equal to or more than 2, of half waves and which satisfies the positive/negative symmetry and a second pattern of which the control period is a second number, equal to or more than 2 and divisible by 4, of half waves and which satisfies the positive/negative symmetry, and wherein the control means sets the second pattern in a case in which the supplying power duty is a first duty and sets the first pattern in a case in which the supplying power duty is a second duty which is the supplying power duty larger by one step or smaller by one step than the first duty, and performs wave number control.

(2) A heating device comprising: a heat generating member connected to an AC power source; a switching element connected between the AC power source and the heat generating member, and configured to be switched between a conductive state in which a power of the AC power source is allowed to be supplied to the heat generating member and a non-conductive state in which the power of the AC power source is not allowed to be supplied to the heat generating member; a control means configured to perform a wave number control in which the power supplied to the heat generating member is controlled by switching the switching element to the conductive state or the non-conductive state for each half wave as a control period of a plurality of continuous in a waveform of an AC voltage of the AC power source; and a detecting means configured to detect a temperature of the heat generating member, wherein the control means determines a supplying power duty which is a ratio of the power suppled to the heat generating member in the control period based on the temperature of the heat generating member detected by the detecting means and a target temperature of the heat generating member, sets a power control pattern defining present/absence of a power supply in each half wave within the control period based on the supplying power duty which is determined, and performs the wave number control in response to the power control pattern which is set, the power control pattern includes a first pattern of which the control period is a first number, equal to or more than 2, of half waves and a second pattern of which the control period is a second number larger than the first number, and wherein the control means sets the second pattern in a case in which the supplying power duty is a first duty and sets the first pattern in a case in which the supplying power duty is a second duty which is the supplying power duty larger by one step or smaller by one step than the first duty, and performs wave number control.

(3) An image forming apparatus for performing image formation on a recording material, the image forming apparatus comprising: a forming means configured to form a toner image on the recording material; and a heating device according to (1), the heating device heating and fixing the toner image to the recoding material.

According to the present invention, even in the case of reducing the resistance value of the heater in order to increase suppliable power thereto, it becomes possible to improve the flicker in the wave number control.

Further features of the present invention will become apparent from the following description of exemplary embodiments with reference to the attached drawings.

### BRIEF DESCRIPTION OF THE DRAWINGS

FIG. 1 is a view illustrating a configuration of an image forming apparatus in Embodiments 1 through 3.

FIG. 2, part (a), part (b) and part (c), includes views illustrating configurations of a fixing device in the Embodiments 1 through 3.

FIG. 3 is a view illustrating a heater driving circuit applied to the Embodiments 1 through 3.

FIG. 4, part (a), part (b) and part (c), includes views illustrating supplying power patterns in the Embodiment 1.

FIG. 5 is a view illustrating a relationship between a heater resistance value and a Pst value in the Embodiment 1

FIG. 6, part (a), part (b) and part (c), includes views illustrating the supplying power patterns in the Embodiment 1.

FIG. 7, part (a) and part (b), includes views illustrating the supplying power patterns in the Embodiment 1.

FIG. 8, part (a) and part (b), includes views illustrating the supplying power patterns applied to the Embodiment 1.

FIG. 9, part (a) and part (b), includes views illustrating effect of the supplying power patterns applied to the Embodiment 1.

FIG. 10 is a flowchart illustrating power supply control in the Embodiment 1.

FIG. 11 is a view illustrating supplying power patterns in the Embodiment 2.

FIG. 12, part (a) and part (b), includes views illustrating the supplying power patterns applied to the Embodiment 2.

FIG. 13, part (a) and part (b), includes views illustrating effect of the supplying power patterns applied to the Embodiment 2.

FIG. 14 is a flowchart illustrating power supply control in the Embodiment 2.

FIG. 15, part (a) and part (b), includes views illustrating supplying power patterns and Pst values in cases in which a control period is eight half waves.

FIG. 16, part (a), part (b), part (c) and part (d), includes views illustrating supplying power patterns applied to the Embodiment 3 and effect thereof.

FIG. 17, part (a) and part (b), includes views illustrating supplying power patterns applied to the Embodiment 3 and effect thereof.

FIG. 18, part (a) and part (b), includes views illustrating supplying power patterns applied to the Embodiment 3 and effect thereof.

### DESCRIPTION OF THE EMBODIMENTS

### Embodiment 1

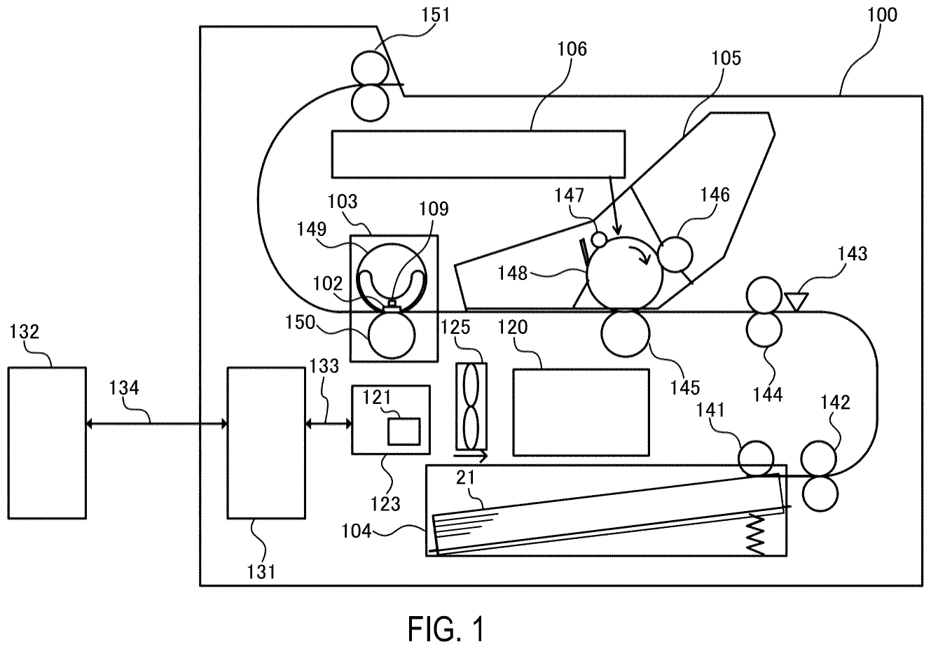

Hereinafter, using the drawings, modes in which the present invention is embodied in an image forming apparatus will be described. FIG. 1 is a cross-sectional view illustrating an outline configuration of the image forming apparatus using an electrophotographic process. Incidentally, in an Embodiment 1, a case of a laser beam printer as an example of the image forming apparatus is described, however, it may also be the image forming apparatus such as a copy machine and a facsimile device or a multifunction machine of these.

### [Image Forming Apparatus]

A main assembly of a laser beam printer 100 (hereinafter, referred to as a main assembly 100) shown in FIG. 1 includes a sheet feeding cassette 104 which accommodates a sheet 21 as a recording material. The main assembly 100 includes a sheet feeding roller 141 which feeds out the sheet 21 from the sheet feeding cassette 104, a conveyance roller pair 142, a top sensor 143, which detects a leading end of the sheet 21, downstream of the conveyance roller pair 142, and a registration roller pair 144 which synchronously conveys the sheet 21. The main assembly 100 includes a cartridge unit 105, which forms a toner image on the sheet 21 based on a laser beam from a laser scanner 106, downstream of the registration roller pair 144. The cartridge unit 105 is constituted by a photosensitive drum 148 as an image bearing member, a charging roller 147, a developing roller 146, etc., which are necessary for a known electrophotographic process, and forms the toner image on the sheet 21 together with a transfer roller 145. The members contributing to form the toner image on the sheet 21 correspond to forming means. And the main assembly 100 includes, downstream of the cartridge unit 105, a fixing unit 103 (fixing device, heating device) for heat fixing the unfixed toner image formed on the sheet 21. The fixing unit 103 includes a fixing film 149, a pressing roller 150, a heater 102 disposed inside the fixing film 149, and a thermistor 109 disposed in a vicinity of the heater 102 so as to detect a temperature of the heater 102 in the fixing film 149. The thermistor 109 is a detecting means which detects the temperature of the heater 102. The main assembly 100 includes a discharging roller pair 151 downstream of the fixing unit 103, and the discharging roller pair 151 discharges, after the toner image formation, the sheet 21 which has been subjected to the heat fixing.

A power source unit 120 as a power supply device (details thereof will be described below) is capable of switching to and outputting a voltage of 24 V or a voltage of 10 V as appropriately, and generates the voltage of 24 V in a print mode or a standby mode. The power source unit 120 supplies, to a high voltage power source (not shown) for supplying a high voltage to an unshown driving unit such as a motor and a clutch and the cartridge unit 105, the voltage of 24 V via an engine controller 123, which will be described below. The power source unit 120 supplies, to a rotatable polygon mirror driving portion (not shown) of the laser scanner 106, etc., the voltage of 24 V as a driving system voltage via the engine controller 123, which will be described below.

A cooling fan 125 is a fan for cooling the power source unit 120, and by blowing air against the power source unit 120, cools the power source unit 120. The cooling fan 125 can blow air only when the voltage of 24 V is output from the power source unit 120.

The engine controller 123 performs control of the main assembly 100. The engine controller 123 controls conveyance of the sheet 21 by operating each roller by controlling a driving unit (not shown). In addition to this, the engine controller 123 performs an image forming (hereinafter, referred to as printing) operation by controlling the laser scanner 106, the cartridge unit 105, the fixing unit 103, etc. In addition, a DC-DC converter 121, which will be described below, is mounted in the engine controller 123, and generates, based on the voltage supplied from the power source unit 120, a voltage of 3.3 V, which is mainly used in a control system. The voltage of 3.3 V is supplied to circuits of the control system including a control circuit disposed inside the engine controller 123 (not shown), a video controller 131, which will be described below, a laser light emitting portion of the laser scanner 106 (not shown), the top sensor 143, etc. The video controller 131 is connected to the engine controller 123 via an engine interface 133 and to an external device 132 such as a personal computer via a general-purpose external interface 134 (USB, etc.).

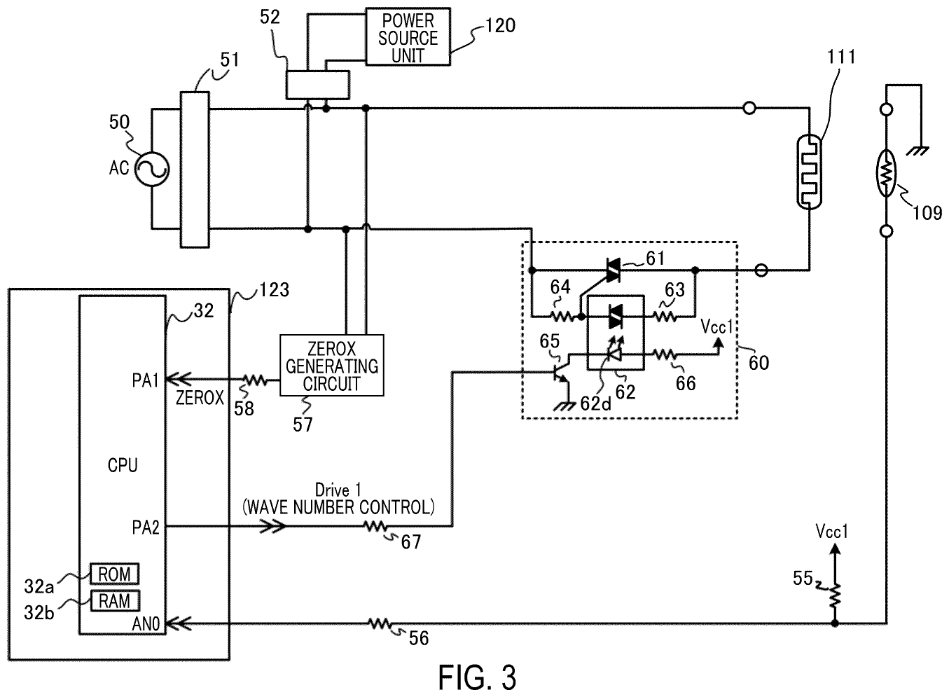

In the power source unit 120, a zero-cross timing of an AC power source 50 (see FIG. 3), which will be described below, is detected and sends a detection signal (not shown) to the engine controller 123. The engine controller 123 controls unshown switching elements as appropriately so that the power from the AC power source 50 becomes a duty ratio of a wave number in synchronization with the detection signal, in other words, the zero-cross timing. Through this, the engine controller 123 controls the heater 102, which is connected in parallel to the AC power source 50, to be a predetermined temperature.

The video controller 131 receives printing information (a number of sheets, various types of settings, etc.) and data for printing through the external interface 134. The video controller 131, inside which an unshown image control portion is mounted, expands the data for printing into image data which is actually printable. Thereafter, the engine controller 123 receives the image data from the video controller 131 via the engine interface 133 at a predetermined timing, and sends the image data to the laser scanner 106.

### [Fixing Unit]

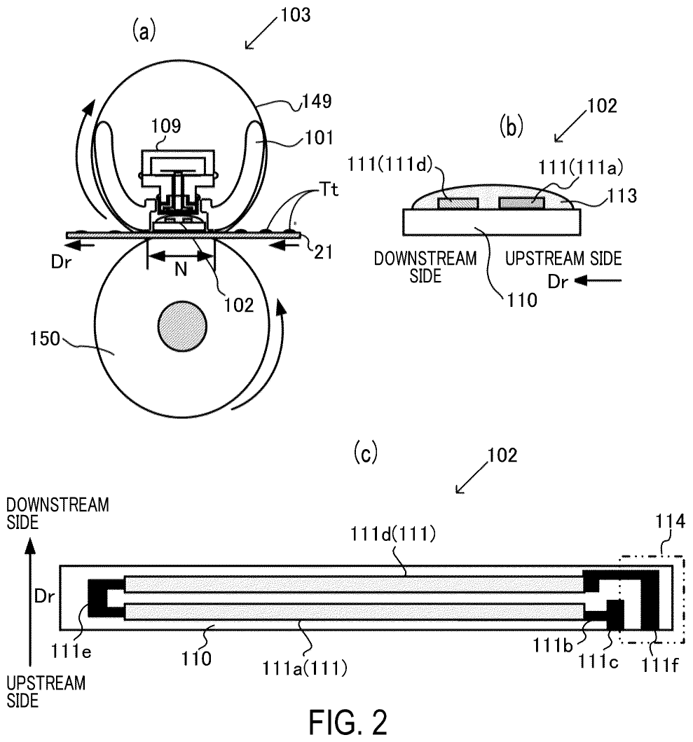

Part (a) of FIG. 2 is a cross-sectional schematic view of the fixing unit 103 in the Embodiment 1. The sheet 21 is conveyed from right to left in part (a) of FIG. 2, and hereinafter, the direction is referred to as a conveyance direction Dr. The fixing unit 103 is, for example, a heating device of a film heating type of a pressing roller driving type using an endless film (cylindrical film), and overall includes a following configuration. That is, the fixing unit 103 includes the heater 102, a heater holder 101 with heat resistance and rigidity having a gutter shape of semicircular arc shape, which fixedly holds the heater 102, and the cylindrical thin heat-resistant film (fixing film) 149 which is loosely fitted outside the heater holder 101 to which the heater 102 is attached. The fixing unit 103 includes the pressing roller 150 as a rotatable pressing member which forms a fixing nip portion N by making a mutual pressure contact with the heater 102 across the fixing film 149, and the thermistor 109 disposed so that a heat-sensitive surface thereof is in contact on a surface of the heater 102.

The pressing roller 150 is rotationally driven by an unshown driving means at a predetermined peripheral speed in a counterclockwise direction indicated by an arrow in part (a) of FIG. 2. Due to pressure contact friction force in the fixing nip portion N, which is a contacting portion between an outer surface of the pressing roller 150 and the fixing film 149, rotating force of the pressing roller 150 acts to the cylindrical fixing film 149, causing the fixing film 149 to be in a rotating state following the rotation of the pressing roller 150. The fixing film 149 performs the rotation operation around the outside of the heater holder 101 in a clockwise direction indicated by an arrow in part (a) of FIG. 2 while an inner surface thereof contacting closely and sliding against a downward surface of the heater 102.

By the power being supplied to the heater 102, a temperature of the heater 102 rises to a predetermined temperature (target temperature), and is controlled. In a state in which the temperature of the heater 102 is controlled, the sheet 21 carrying an unfixed toner image Tt is conveyed to the fixing nip portion N. In the fixing nip portion N, a toner image carrying surface side of the sheet 21 contacts closely an outer surface of the fixing film 149, and is nipped and conveyed through the fixing nip portion N together with the fixing film 149. During the nipping and conveying process, heat of the heater 102 is applied to the sheet 21 via the fixing film 149, and the unfixed toner image Tt on the sheet 21 is heated and pressurized to be melted and fixed to the sheet 21. The sheet 21 which has passed through the fixing nip portion Nis separated from the fixing film 149 due to a curvature thereof.

Part (b) of FIG. 2 is an enlarged cross-sectional schematic view of the heater 102. The heater 102 is a ceramic heater of a back surface heating type. The heater 102 includes an insulating substrate 110 made of ceramics such as SiC, AlN and Al₂O₃, heat generating members 111a and 111d formed by paste printing, etc. on the insulating substrate 110, and a protective layer 113 such as glass which protects the two heat generating members 111a and 111d. There is a case in which a glass layer is formed on an opposing surface side to the insulating substrate 110 on which the heat generating members 111a and 111d are printed in order to improve sliding property.

Part (c) of FIG. 2 is a plan schematic view of the heater 102. The heater 102 includes the two heat generating members 111a and 111d, electrodes 111c and 111f, a conductive portion 111b which connects the heat generating member 111a and the electrode 111c, and a conductive portion 111e which connects the heat generating member 111a and the heat generating member 111d. By the power being supplied via the electrode 111c and the electrode 111f, the heat generating members 111a and 111d generate heat. The power supply is performed via a connector 114 for power supply. Hereinafter, the heat generating member 111a and the heat generating member 111d may also be collectively referred to as a heat generating member 111.

### [Heater Driving Circuit]

FIG. 3 is a circuit view for describing a heater driving circuit in the Embodiment 1, and shows a power supply circuit in the present invention. The AC power source 50 is a power source to which the image forming apparatus is connected, and AC power is supplied to the image forming apparatus via an inlet 51. The power supply circuit is constituted by, overall, a primary side which is connected directly to the AC power source 50 and a secondary side which is connected to the AC power source 50 without contact.

The power input from the AC power source 50 is supplied to the heat generating member 111 via the inlet 51, and causes the heat generating member 111 to generate heat. To the power source unit 120, the power of the AC power source 50 is input via an AC filter 52, and outputs a predetermined voltage to a load on the secondary side. To the engine controller 123, a CPU 32 is mounted. The CPU 32 is also used for heater driving control, etc., and is constituted by each input/output port (PA1, PA2, AN0), a ROM 32a, a RAM 32b, etc. The CPU 32 is a control means which performs a wave number control in which the power supplied to the heat generating member 111 is controlled by switching a triac 61, which will be described below, to a conductive state or a non-conductive state for each half wave with a plurality of continuous half waves as a control period in a waveform of an AC voltage of the AC power source 50. The CPU 32 determines a supplying power duty which is a ratio of the power supplied to the heater 102 in the control period based on the temperature of the heater 102 detected by the thermistor 109 and the target temperature of the heater 102. The CPU 32 sets a power control pattern defining presence/absence of the power supply in each half wave within the control period based on the supplying power duty which is determined, and performs the wave number control in response to the power control pattern which is set. Hereinafter, the power control patten is referred to as a wave number control pattern. In addition, details of the wave number control will be described below.

In the image forming apparatus in the present Embodiment, it is a configuration in which on the primary side of the power supply circuit, the heat generating member 111 of the fixing unit 103 and the power source unit 120 for supplying the power to the secondary side are directly connected to the AC power source 50 to receive the power supply. In addition, on the secondary side of the power supply circuit, it is a configuration in which a high voltage power source (not shown) for supplying high voltage to an unshown driving unit, such as a motor and a clutch, and a cartridge unit 105 is connected to the AC power source 50 without contacting to receive the power supply. In addition, the rotatable polygon mirror driving portion (not shown) of the laser scanner 106, etc. are also connected to the AC power source 50 without contacting to receive the power supply.

To the heat generating member 111, a predetermined amount of power is supplied by a wave number control circuit 60. In the thermistor 109, which is disposed on a back surface of the heater 102, one end thereof is connected to ground, and the other end thereof is connected to a resistor 55, and is further connected to the analog input port AN0 of the CPU 32 via a resistor 56. The thermistor 109 has a characteristic that a resistance value thereof gets decreased as a temperature thereof becomes higher. The CPU 32 detects the temperature of the heater 102, based on a divided voltage between the thermistor 109 and the resistor 55, by converting the voltage to a temperature with referring to a preset temperature table (not shown) stored in the ROM 32a.

On the other hand, the power of the AC power source 50 is input to a zero-cross generating circuit 57 (ZEROX generating circuit) via the AC filter 52. The zero-cross generating circuit 57 outputs a high level signal when the AC voltage is equal to or lower than a certain threshold voltage near 0 V, and outputs a low level signal in the other cases. To the CPU 32, a pulse signal (hereinafter, referred to as a ZEROX signal) with a period substantially equal to the period of the AC voltage of the AC power source 50 is input to the input port PA1 via a resistor 58. The CPU 32 detects an edge at which the ZEROX signal is changed from the high level to the low level, and uses it for a timing control of the wave number control. The CPU 32 determines a timing (hereinafter, referred to as a lighting timing) at which the CPU 32 drives the wave number control circuit 60 based on the temperature detected by thermistor 109, and outputs a driving signal (Drive1) from the output port PA2.

### (Wave Number Control Circuit)

The wave number control circuit 60 will be described. By the output port PA2 being high level at a predetermined lighting timing, a transistor 65 is turned on via a base resistor 67. The base resistor 67 is connected to a base terminal of the transistor 65. By the transistor 65 being turned on, a phototriac coupler 62 is turned on. Incidentally, the phototriac coupler 62 is a device to ensure a creepage distance between the primary and the secondary, and a resistor 66 is a resistor for limiting a current flowing into a light emitting diode 62d in the phototriac coupler 62. When the transistor 65 is turned on, a current flows from a power source Vcc1 via the resistor 66, and the light emitting diode 62d emits light.

Resistors 63 and 64 are bias resistors for a bidirectional thyristor (hereinafter, referred to as a triac) 61, and by the phototriac coupler 62 being turned on, the triac 61 is electrically connected. The triac 61 is provided between the AC power source 50 and the heater 102, and is a switching element which is switched between a conductive state in which the power of the AC power source 50 is allowed to be supplied to the heater 102 and a non-conductive state in which the power of the AC power source 50 is not to be supplied to the heater 102.

In a case in which the phototriac coupler 62 is a zero-cross type, the triac 61 is electrically connected at a timing when the AC voltage of the AC power source 50 is equal to or lower than a predetermined voltage and when the transistor 65 is in the ON state. In the Embodiment 1, the phototriac coupler of the zero-cross type is used, and the CPU 32 turns on, based on the signal generated by the zero-cross generating circuit 57, the transistor 65 near the zero-cross timing. With this, it is configured so that the wave number control can be accurately performed even in a case in which frequency fluctuation occurs, however, it is not limited to this configuration. For example, without the zero-cross generating circuit 57, the wave number control may be performed by the phototriac coupler of the zero-cross type. In addition, for example, it may be a configuration in which a phototriac coupler of a non-zero-cross type is used, and based on the signal generated by the zero-cross generating circuit 57, the transistor 65 is turned on near the zero-cross timing, etc.

### [Power Supply by the Wave Number Control]

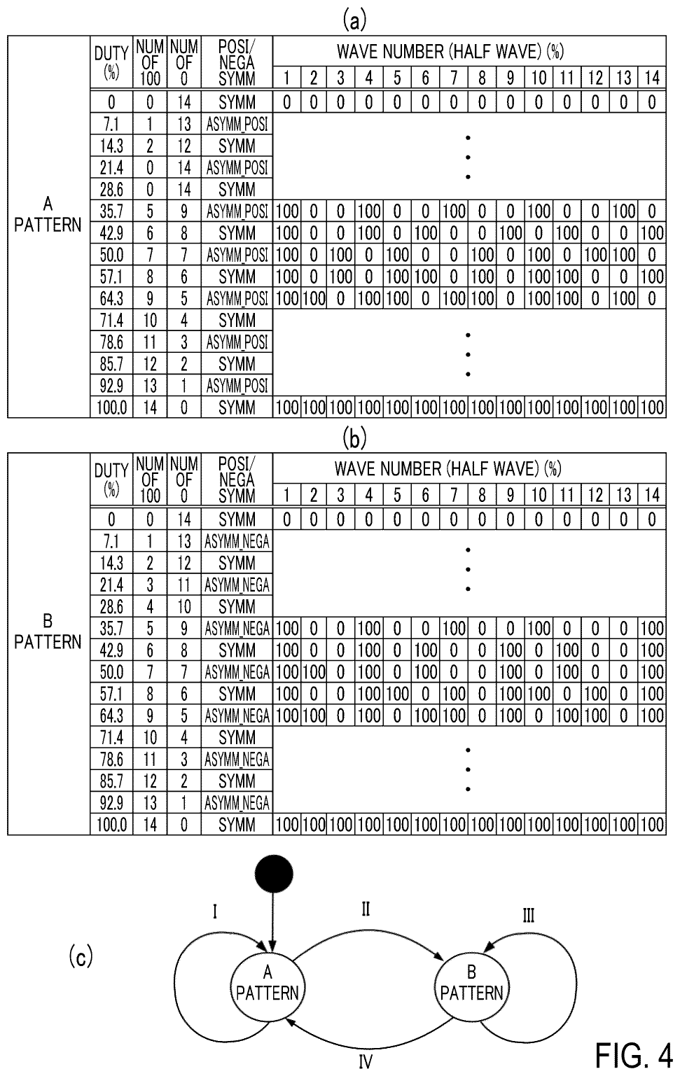

A wave number control method in which the CPU 32 uses the wave number control circuit 60 to perform power supply to the heater 102 will be described using FIG. 4. Part (a) of FIG. 4 is a view showing a pattern A of the wave number control and part (b) of FIG. 4 is a view showing a pattern B thereof. As also described in FIG. 3, in the wave number control, since the heater 102 can only be turned on and off near the zero-cross timing, only 100% or 0% can be selected for the power supply at each half wave. In other words, it becomes a control of either supplying the power (100%) or not supplying the power (0%) in one half wave of a waveform, which is a half period of the AC voltage of the AC power source 50.

As shown in part (a) of FIG. 4 and part (b) of FIG. 4, in the wave number control, the supplying power duty in the control period is determined by for how many wave numbers, the heater 102 is turned on in the control period of a unit of a predetermined number of the half waves (hereinafter, referred to as a wave number). In a case of FIG. 4, the control period for the wave number control is set to fourteen half waves. In addition, one control period starts from a positive half wave in the AC voltage waveform. Thus, within one control period, the odd-numbered half waves are positive half waves, and the even-numbered half waves are negative half waves. Incidentally, the number of half waves included in the control period may also be referred to as a wave number length.

As shown in part (a) and part (b) of FIG. 4, in a case in which the supplying power duty (DUTY) for one control period is set to 0%, the power supplied in all half waves from a first half wave to a fourteenth half wave is 0% in both the pattern A and the pattern B. On the other hand, in a case in which the supplying power duty for one control period is set to 35.7%, in the pattern A, from the first half wave to the fourteenth half wave, the power supplied is 100%, 0%, 0%, 100%, 0%, 0%, 100%, 0%, 0%, 100%, 0%, 0%, 100% and 0%. In addition, in the case in which the supplying power duty for one control period is set to 35.7%, in the pattern B, from the first half wave to the fourteenth half wave, the power supplied is 100%, 0%, 0%, 100%, 0%, 0%, 100%, 0%, 0%, 100%, 0%, 0%, 0% and 100%. The information like the pattern A or the pattern B which defines the power supply of 0% or 100% for the plurality of the half waves included in the control period in order to realize a predetermined supplying power duty (%) is the wave number control pattern. The wave number control patterns are stored as a pattern table in the ROM 32a, for example.

The supplying power duty is calculated by the CPU 32 by a PID (Proportional Integral Derivative) control, for example, from the temperature detected by the thermistor 109 and the preset target temperature. The CPU 32 selects, every control period, an optimal supplying power duty from the wave number control patterns shown in part (a) of FIG. 4 and part (b) of FIG. 4. In the wave number control patterns in part (a) of FIG. 4 and part (b) of FIG. 4, of fourteen half waves in the control period, as a number of the wave number in which 100% of the power is supplied is increased by one half wave, the supplying power duty is increased by about 7.1% (≈(1÷14)×100%). By this, it becomes possible to adjust the power in a range from 0% to 100% with the supplying power duty having fifteen steps. In part (a) of FIG. 4 and part (b) of FIG. 4, the number of half waves in which 100% of the power is supplied and the number of half waves in which 0% of the power is supplied (the power is not supplied) are also described, respectively. In part (a) of FIG. 4 and part (b) of FIG. 4, for simplifying description, for the supplying power duty from 7.1% to 28.6% and from 71.4% to 92.9%, contents of detailed patterns are omitted.

In the power control of the heater 102, positive/negative symmetry of the power supply pattern is required. Here, the positive/negative symmetry refers to a fact that a number of positive half waves in which the triac 61 becomes the conductive state in the control period and a number of negative half waves in which the triac 61 becomes the conductive state in the control period become the same number. In part (a) of FIG. 4 and part (b) of FIG. 4, the positive/negative symmetry for each supplying power duty is also shown. As shown in part (a) of FIG. 4 and part (b) of FIG. 4, in patterns in which a number of 100% is an odd number (in the case described above in which the DUTY is 35.7%, etc.), by only each pattern, the positive/negative symmetry is not satisfied. Conversely, in patterns in which a number of 100% is an even number, by only each pattern, the positive/negative symmetry is satisfied.

In the pattern A shown in part (a) of FIG. 4, in an asymmetric case, it is a pattern in which the positive half wave (hereinafter, referred to as a positive side) is more by one. On the other hand, in the pattern B shown in part (b) of FIG. 4, in the asymmetric case, it is a pattern in which the negative half wave (hereinafter, referred to as a negative side) is more by one. For example, in the case in which the supplying power duty is 35.7%, in the pattern A, the thirteenth half wave is 100% and the positive half wave is more by one, while in the pattern B, the fourteenth half wave is 100% and the negative half wave is more by one.

Part (c) of FIG. 4 is view illustrating a state of transitions (I through IV) selected between the pattern A and the pattern B in the wave number control. As shown in part (c) of FIG. 4, in a case in which the wave number in which the power is output is an even number, then the power is output again in the original pattern. On the other hand, in a case in which the wave number in which the power is output is an odd number, a control in which if the original pattern is the pattern A, then the power is output in the pattern B next, and if the original pattern is the pattern B, then the power is output in the pattern A next is performed.

For example, in a case in which the number of half waves in which 100% of the power is supplied is an even number in the supplying power duty selected from the pattern A, then since the positive/negative symmetry is satisfied, the supplying power duty is selected from the pattern A also in the next control period (the transition I). On the other hand, in a case in which the number of half waves in which 100% of the power is supplied is an odd number in the supplying power duty selected from the pattern A, then since the positive/negative symmetry is not satisfied, the supplying power duty is selected from the pattern B in the next control period to satisfy the positive/negative symmetry (the transition II). In a case in which the number of half waves in which 100% of the power is supplied is an even number in the supplying power duty selected from the pattern B, then since the positive/negative symmetry is satisfied, the supplying power duty is selected from the pattern B also in the next control period (the transition III). On the other hand, in a case in which the number of half waves in which 100% of the power is supplied is an odd number in the supplying power duty selected from the pattern B, then since the positive/negative symmetry is not satisfied, the supplying power duty is selected from the pattern A in the next control period to satisfy the positive/negative symmetry (the transition IV).

By performing the control in this manner, the engine controller 123 is configured to satisfy the positive/negative symmetry. By performing the control in this manner, it becomes possible, while satisfying the positive/negative symmetry, to perform the power control without reducing power resolution.

### [Flicker]

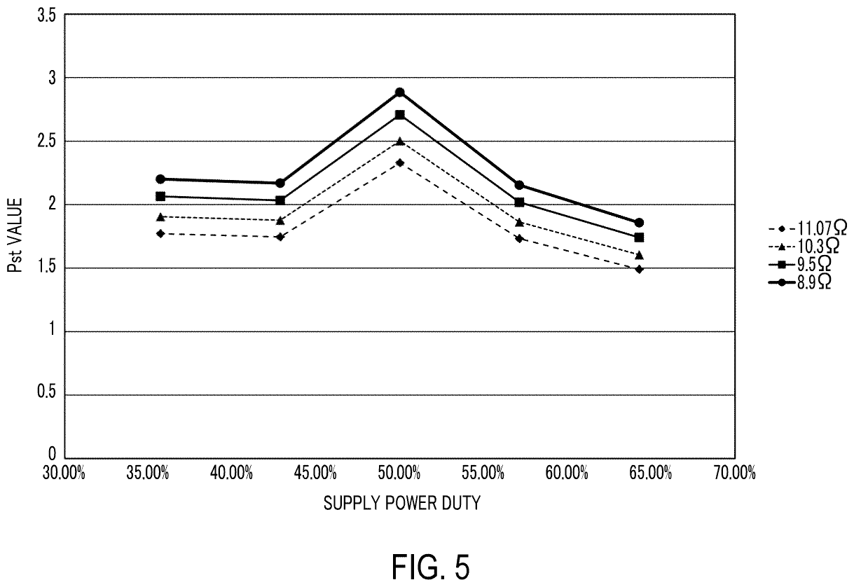

Next, FIG. 5 is a view showing a relationship between the supplying power duty (%) and a Pst value (Perceptibility Short-Term), which is short-term flicker index, upon changing (varying) a resistance value of the heater 102. In FIG. 5, a horizontal axis represents the supplying power duty (%) and a vertical axis represents the Pst value for each resistance value of the heater 102. A thick solid line shows the Pst values when the resistance value of the heater 102 is 8.9Ω, a thin solid line shows the Pst values when the resistance value of the heater 102 is 9.5Ω, a dotted line shows the Pst values when the resistance value of the heater 102 is 10.3Ω, and a broken line shows the Pst values when the resistance value of the heater 102 is 11.07Ω.

The Pst value is the short-term flicker value (voltage fluctuation value), and the larger the value, the more significant the fluctuation and the more significant effect due to the flicker. As shown in FIG. 5, the smaller the resistance value of the heater 102, the larger the Pst value. In addition, in any resistance value, the Pst value when the supplying power duty is 50% is higher than the Pst values when the supplying power duty is the other values. In order to reduce the resistance value to increase the power to be supplied to the heater 102, it is necessary to improve the flicker especially when the supplying power duty is 50%.

[Wave Number Control Patten when the Supplying Power Duty is 50%]

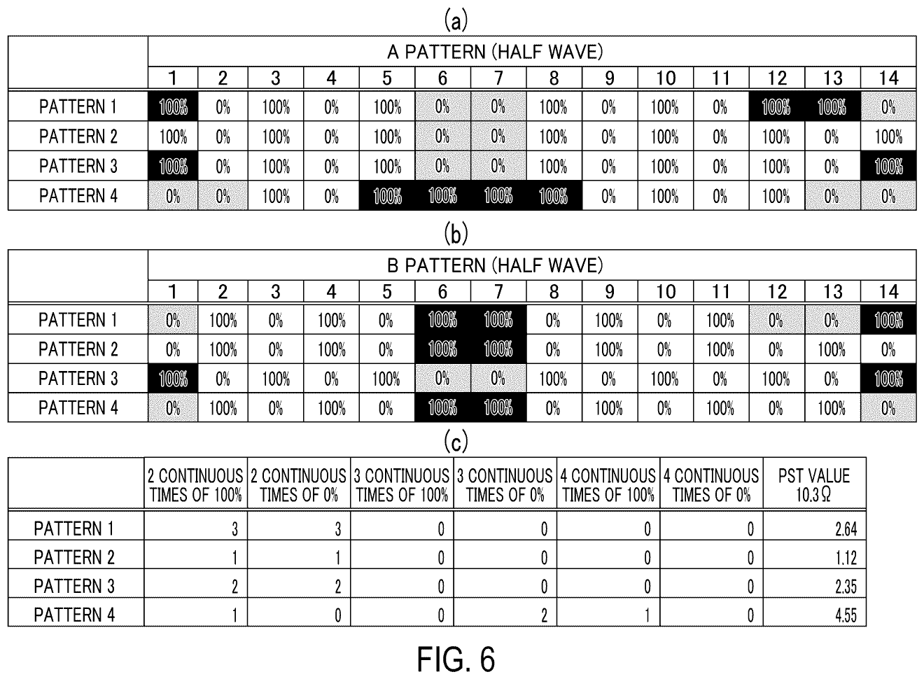

Part (a) of FIG. 6 and part (b) of FIG. 6 show four kinds of the wave number control patterns (patterns 1 through 4), which has the period of the fourteen half waves and of which the supplying power duty is 50%, and part (c) of FIG. 6 is a view showing the Pst values of the patterns 1 through 4. Part (a) of FIG. 6 shows the pattern A and part (b) of FIG. 6 shows the pattern B. The Pst values in part (c) of FIG. 6 represent the Pst values when the resistance value of the heater 102 is 10.3Ω. Portions of which background is painted gray in each pattern are portions in which 0% continues equal to or more than twice. Portions of which background is painted black in each pattern are portions in which 100% continues equal to or more than twice. Incidentally, the fourteenth half wave of the pattern A and the first half wave of the pattern B are continuous, and the fourteenth half wave of the pattern B and the first half wave of the pattern A are continuous during the wave number control.

In part (c) of FIG. 6, the respective number of times of the continuation of 100% and 0% for each pattern are described. In the pattern 1, a twice-continued number of times is three times for both 100% and 0%, in the pattern 2, the twice-continued number of times is once for both 100% and 0%, and in the pattern 3, the twice-continued number of times is twice for both 100% and 0%. Among the pattern 1 through the pattern 3, the Pst value is low (1.12) in the pattern 2, in which the twice-continued number of times is least for both 100% and 0%, and the Pst value is high (2.64) in the pattern 1, in which the twice-continued number of times is most for both 100% and 0%. In addition, compared to the pattern 1 through the pattern 3, in the pattern 4, in which a three or more-times-continued number of times is more for 100% or 0%, the Pst value is highest (4.55).

Based on these, it can be found that it is possible to reduce the Pst value by configuring that the same power supply of 100% and 0% do not continue. In the case in which the supplying power duty is 50% for the control period of fourteen half waves, it becomes possible to reduce the flicker significantly by reducing the number of times in which the same power supply of 100% and 0% continues, as in the pattern 2.

[Wave Number Control Pattern when the Supplying Power Duty is Around 50%]

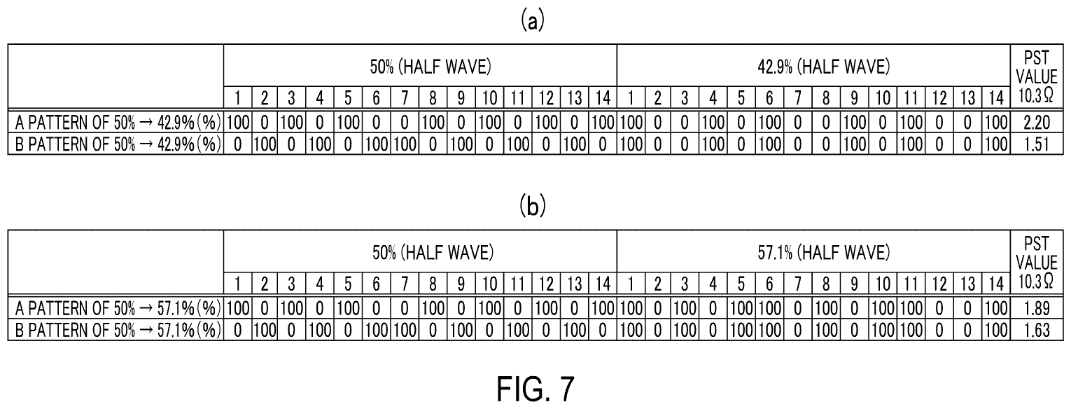

Part (a) of FIG. 7 is a view showing the wave number control patterns and the Pst values in a case in which the pattern A and the pattern B when the supplying power duty is 50%, which is described in FIG. 6, and the pattern of 42.9%, which is the supplying power duty one step lower than 50%, are repeated. Part (b) of FIG. 7 is a view showing the wave number control patterns and the Pst values in a case in which the pattern A and the pattern B when the supplying power duty is 50% and the pattern of 57.1%, which is the supplying power duty one step higher than 50%, are repeated.

The supplying power duty is determined by the PID control, etc. based on the temperature detected by the thermistor 109 and the preset target temperature. Therefore, the temperature control is not always performed with a fixed supplying power duty, but often repeats adjacent supplying power duties. Therefore, it is necessary to configure the wave number control pattern which takes into account that the Pst value becomes low even in the case of being operated with the adjacent supplying power duties.

As shown in part (a) of FIG. 7, in a case in which the pattern A of the supplying power duty of 50% and the pattern A of the supplying power duty of 42.9% are repeated, the Pst value becomes 2.2. On the other hand, in a case in which the pattern B of the supplying power duty of 50% and the pattern B of the supplying power duty of 42.9% are repeated, the Pst value becomes 1.51. In the pattern A (pattern 2) of the supplying power duty of 50%, the first half wave and the fourteenth half wave are 100%, and also in the pattern A of the supplying power duty of 42.9%, the first half wave and the fourteenth half wave are 100%. Therefore, since 100% continues twice at a timing when the supplying power duty is switched, effect of the flicker becomes significant.

As shown in part (b) of FIG. 7, in a case in which the pattern A of the supplying power duty of 50% and the pattern A of the supplying power duty of 57.1% are repeated, the Pst value becomes 1.89. On the other hand, in a case in which the pattern B of the supplying power duty of 50% and the pattern B of the supplying power duty of 57.1% are repeated, the Pst value becomes 1.63. In the pattern A of the supplying power duty of 50%, the first half wave and the fourteenth half wave are 100%, and also in the pattern A of the supplying power duty of 57.1%, the first half wave and the fourteenth half wave are 100%. Therefore, since 100% continues twice at the timing when the supplying power duty is switched, the effect of the flicker becomes significant.

As described above, in the supplying power duty of 50% of the fourteen half waves, since the number of times of the power supply of 100% is an odd number, in order to satisfy the positive/negative symmetry, both the pattern A and the pattern B are required. In this case, in the case of switching from the pattern A to the adjacent supplying power duty, the effect due to the flicker becomes significant. Therefore, it is necessary to configure the wave number control patten so that the effect due to the flicker does not become significant even in the case of switching to the adjacent supplying power duty.

### [Wave Number Control Pattern in the Embodiment 1]

The wave number control pattern in the Embodiment 1 includes a first pattern of which the control period is a first number, which is a number equal to or more than two, of half waves and which satisfies the positive/negative symmetry and a second pattern of which the control period is a second number, which is a number equal to or more than two and divisible by four, of half waves and which satisfies the positive/negative symmetry. Here, in the Embodiment 1, the second number is larger than the first number. The CPU 32 sets the second pattern in a case in which the supplying power duty is a first duty and sets the first pattern in a case in which the supplying power duty is a second duty which is the adjacent supplying power duty to the first duty, and performs the wave number control. Incidentally, it can also be said that the second duty is the supplying power duty larger by one step or smaller by one step than the first duty. For example, the first duty is the supplying power duty of 50%. In the Embodiment 1, hereinafter, it will be described as the second number is sixteen (the control period is sixteen half waves) and the first number is fourteen (the control period is fourteen half waves). In addition, the second duty is the supplying power duty of 42.9% and the supplying power duty of 57.1%.

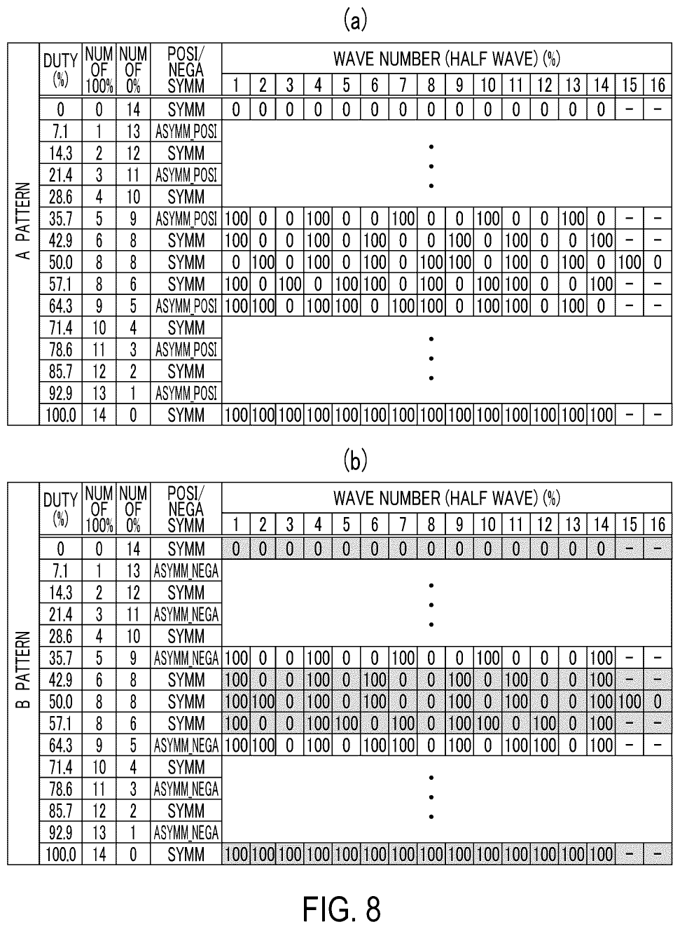

FIG. 8 includes views illustrating the wave number control patterns in the Embodiment 1. Part (a) of FIG. 8 is a view illustrating the supplying power duty of 0% through 100% in the pattern A of the wave number control pattern in the Embodiment 1, and part (b) of FIG. 8 is a view illustrating the supplying power duty of 0% through 100% in the pattern B of the wave number control pattern in the Embodiment 1. Incidentally, in both cases, the supplying power duty of 7.1% through 28.6% and 71.4% through 92.9% are omitted. The information on the supplying power duty of 0% through 100% in the pattern A and the pattern B shown in FIG. 8 is stored in advance in the ROM 32a as the pattern table.

In the pattern A in part (a) of FIG. 8 and in the pattern B in part (b) of FIG. 8, the wave number control patterns of the supplying power duty of 42.9% and the supplying power duty of 57.1% correspond to the first pattern described above. In addition, in the pattern A in part (a) of FIG. 8 and in the pattern B in part (b) of FIG. 8, the wave number control pattern of the supplying power duty of 50% corresponds to the second pattern described above.

A portion which differs remarkably from the wave number control pattern described in FIG. 4 is a portion in which the supplying power duty is 50%. Only in the supplying power duty of 50%, the control period is changed to sixteen half waves. The wave number control pattern in the Embodiment 1 is a common pattern for the pattern A and the pattern B, and is configured so that with only one of the patterns, the positive/negative symmetry can be satisfied. Hatched portions in part (b) of FIG. 8 are the half waves in which the power supplies are set to the same as the pattern A. In the wave number control pattern in the supplying power duty of 50% in the Embodiment 1, the control period is sixteen half waves, and the number of half waves in which the 100% of the power is supplied is eight in both patterns, so that the positive/negative symmetry is satisfied. In addition, by configuring the pattern A and the pattern B as the common pattern, it also becomes possible to solve the problem that the Pst value becomes large upon the switching of the supplying power duty, as described in FIG. 7.

### [Comparison Between the Embodiment 1 and a Conventional Example]

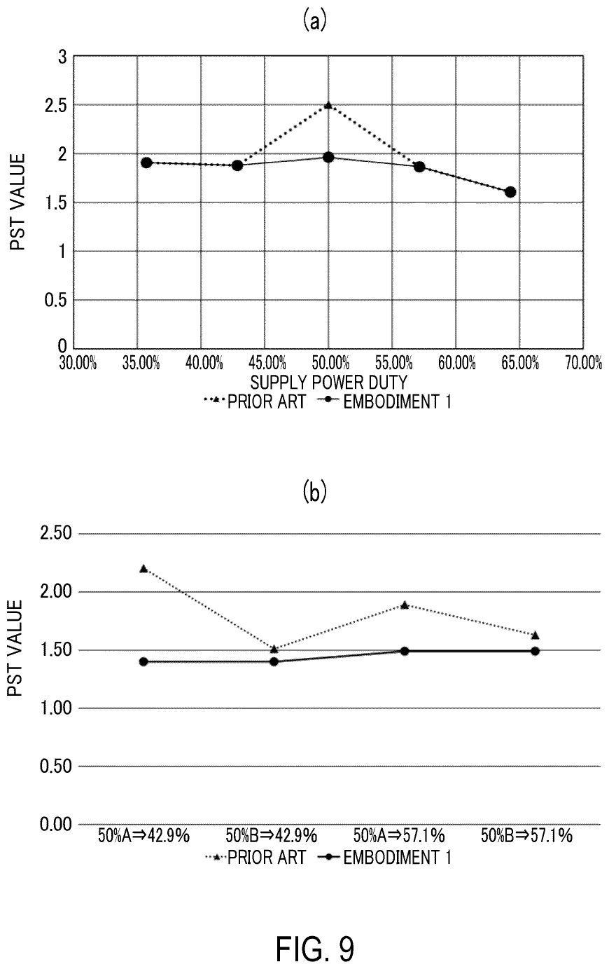

Part (a) of FIG. 9 is a view showing a relationship between the supplying power duty and the Pst value in a Conventional Example described in FIG. 4 and the Embodiment 1, and the Embodiment 1 is represented by a solid line and the Conventional Example is represented by a broken line. Examining the supplying power duty of 50%, it can be found that a significant improvement from the Pst value of 2.5 in the Conventional Example to the Pst value of 1.9 in the Embodiment 1 is achieved.

Part (b) of FIG. 9 is a view showing the Pst values upon switching the supplying power duty from 50% to 42.9% and to 57.1% in the Conventional Example and in the Embodiment 1. From left of a horizontal axis, a case in which the supplying power duty is switched from 50% to 42.9% in the pattern A, and a case in which the supplying power duty is switched from 50% to 42.9% in the pattern B are shown. Furthermore, a case in which the supplying power duty is switched from 50% to 57.1% in the pattern A, and a case in which the supplying power duty is switched from 50% to 57.1% in the pattern B are shown.

The Pst value upon switching the supplying power duty from 50% to 42.9% is also improved from the Pst value of 2.2 to 1.4 in the pattern A, which has the largest value thereof. Similarly, the Pst value upon switching the supplying power duty from 50% to 57.1% is also improved from the Pst value of 1.89 to 1.49 in the pattern A, which has the largest value thereof.

As described above, in the Embodiment 1, it is configured that the control period of the wave number control pattern of the supplying power duty of 50% is set to the number which satisfies the positive/negative symmetry, i.e., to the control period divisible by four. For example, the control period of the wave number control pattern is set to sixteen half waves, which is divisible by four. By this, it becomes possible to realize the significant improvement of the flicker, and to increase the suppliable power to the heater 102 by reducing the resistance value thereof.

### [Power Supply Control for the Heater]

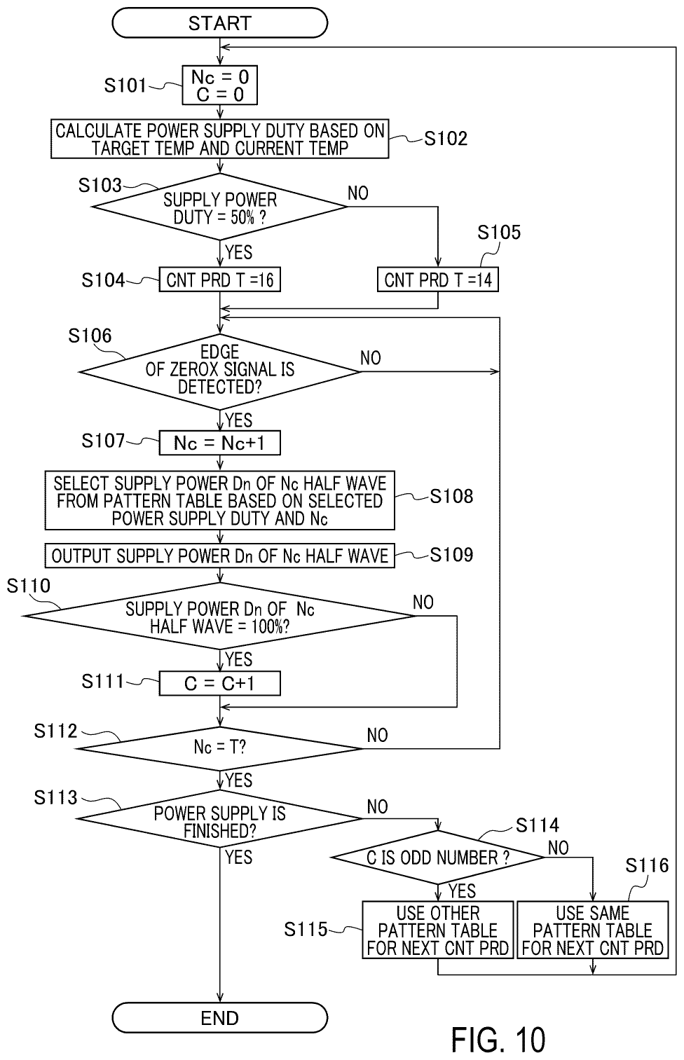

FIG. 10 is a flowchart for describing power supply control (power supply sequence) for the heater 102 in the Embodiment 1. In Step (hereinafter, referred to as S) 101, the CPU 32 initializes a counter Nc, which counts a number of waves, and a counter C, which counts a number of half waves in which 100% of the power is supplied (a number of times of 100% supply) in the control period (Nc=0, C=0). In S102, the CPU 32 calculates the supplying power duty based on the target temperature in the temperature control and a current temperature detected by the thermistor 109.

In S103, the CPU 32 determines whether or not the supplying power duty calculated in S102 is 50%. In S103, if the CPU 32 determines that the supplying power duty is 50%, then proceed the process to S104, and if determines that it is not 50%, then proceeds the process to S105. In S104, the CPU 32 sets a control period T to the control period divisible by four, for example, to the sixteen half waves (T=16) described above, and proceeds the process to S106. In S105, the CPU 32 sets the control period T to the control period not divisible by four, for example, to the fourteen half waves (T=14) described above, and proceeds the process to S106.

In S106, the CPU 32 determines whether or not a falling edge or a leading edge of the ZEROX signal received from the zero-cross generating circuit 57 is detected. In S106, if the CPU 32 determines that the falling edge or the leading edge of the ZEROX signal received from the zero-cross generating circuit 57 is detected, then proceeds the process to S107, and if determined that it is not detected, then returns the process to S106. In S107, the CPU 32 increments the counter Nc (Nc=Nc+1). In S108, the CPU 32 selects, based on the supplying power duty calculated in S102 and the counter Nc, a power supply Dn for the half wave in the counter Nc (Nc-th half wave) from the pattern table stored in advance in the ROM 32a. For example, in a case in which the supplying power duty is 50% and the counter Nc=1, which is the first half wave, when the pattern A is used, the power supply Dn is 0% (part (a) of FIG. 8), and when the pattern B is used, the power supply Dn is 100% (part (b) of FIG. 8).

In S109, the CPU 32 outputs the power supply Dn for the half wave at the counter Nc (Nc-th half wave). Incidentally, in the case in which the power supply Dn is 0%, there is no power supply. In S110, the CPU 32 determines whether or not the power supply Dn for the half wave at the counter Nc (Nc-th half wave) is 100%. In S110, if the CPU 32 determines that the power supply Dn is 100% (Dn=100%), then proceeds the process to S111, and if determines that the power supply Dn is not 100% (Dn=0%), then proceeds the process to S112. In S111, the CPU 32 increments the counter C (C=C+1). By this, the CPU 32 counts a number of times of the power supply of 100% in the control period, in other words, a number of waves (number of half waves) in which 100% of the power is supplied.

In S112, the CPU 32 determines whether or not the counter Nc is equal to the control period T. In other words, the CPU 32 determines whether or not one control period of the supplying power duty calculated in S102 is completed. In S112, if the CPU 32 determines that the counter Nc is equal to the control period T, then proceeds the process to S113, and if determines that it is not equal thereto, then returns the process to S106 and executes the processes of S106 through S111. In S113, the CPU 32 determines whether or not the power supply to the heater 102 is completed. In S113, if the CPU 32 determines that the power supply is not completed, then proceeds the process to S114.

In S114, the CPU 32 determines whether or not the counter C is an odd number. In S114, if the CPU 32 determines that the counter C is an odd number, then proceeds the process to S115, and if the CPU 32 determines that the counter C is not an odd number (is an even number), then proceeds the process to S116. In S115, the CPU 32 determines to use, in the next control period, the other pattern table different from the pattern table used in the current control period, and returns the process to S101. For example, if the pattern A is used in the current control period, then the CPU 32 uses the pattern B in the next control period. In S116, the CPU 32 determines to use the same pattern table as the pattern table used in the current control period, and returns the process to S101. For example, if the pattern A is used in the current control period, then the CPU 32 uses the pattern A in the next control period. The processes of S114 through S116 are the control which have been described in part (c) of FIG. 4.

Incidentally, the wave number control pattern includes a third pattern of which the control period is the first number of half waves and which does not satisfy the positive/negative symmetry. Here, in the example in FIG. 8, the first number is fourteen (the control period is fourteen half waves). The third pattern includes a fourth pattern of which the number of positive half waves in which the triac 61 becomes the conductive state is more than the number of negative half waves in which the triac 61 becomes the conductive state, and a fifth pattern of which the number of negative half waves in which the triac 61 becomes the conductive state is more than the number of positive half waves in which the triac 61 becomes the conductive state. For example, in the pattern A in part (a) of FIG. 8, the wave number control patterns of the supplying power duty of 35.7% and the supplying power duty of 64.3% correspond to the third pattern and the fourth pattern. In addition, in the pattern B in part (b) of FIG. 8, the wave number control patterns of the supplying power duty of 35.7% and the supplying power duty of 64.3% correspond to the third pattern and the fifth pattern. If the wave number control if performed with the fourth pattern, then the CPU 32 performs the wave number control with the fifth pattern in the next control period, and if the wave number control is performed with the fifth pattern, then the CPU 32 performs the wave number control with the fourth pattern in the next control period (S114 to S115 or S116) (the transitions II and IV in part (c) of FIG. 4).

In this manner, until the CPU 32 determines that the power supply is completed in S113, by repeating S114 through S116 and S101 through S112, the CPU 32 supplies the power to the heater 102 while changing the supplying power duty every control period. Finally, at a timing when the CPU 32 determines that the power supply is completed in S113 due to an end of a print sequence, etc., the power supply sequence in FIG. 10 ends.

With the sequence described above, while configuring the control period of the supplying power duty of 42.9%, 57.1%, etc., to the wave number length of fourteen half waves, which is an arbitrary wave number length, the control period of the supplying power duty of 50% is configured to be the wave number length which is divisible by 4 to satisfy the positive/negative symmetry. By this, it becomes possible to improve the flicker upon switching to the adjacent supplying power duty. With the improvement of the flicker, it becomes possible to reduce the resistance value of the heater 102, and to increase the suppliable power to the heater 102.

As described above, according to the Embodiment 1, even in the case of reducing the resistance value of the heater in order to increase the suppliable power thereto, it becomes possible to improve the flicker in the wave number control.

### Embodiment 2

In the Embodiment 1, an example in which the flicker is improved by configuring the control period of the supplying power duty of 50% from fourteen half waves to sixteen half waves, with which the positive/negative symmetry is satisfied, is described. In an Embodiment 2, an example in which the supplying power duty and the control period of other than 50% are shortened will be described.

[Supplying Power Duty of Other than 50%]

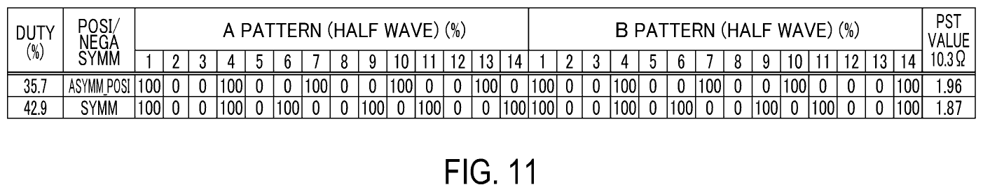

FIG. 11 shows wave number control patterns (a pattern A and a pattern B) and respective Pst values thereof when the supplying power duty is 35.7% and 42.9%. Incidentally, the Pst values represent a case in which the resistance value of the heater 102 is 10.3Ω, as in the Embodiment 1. As shown in FIG. 11, in the case in which the supplying power duty is 35.7%, the Pst value is 1.96, and in the case in which the supplying power duty is 42.9%, the Pst value is 1.87. The wave number control patten for the supplying power duty of 35.7% cannot satisfy the positive/negative symmetry since the power supply is set to 100% at five half waves out of fourteen half waves. Therefore, in order to satisfy the positive/negative symmetry, it is necessary to prepare the pattern A and the pattern B. As described in the Embodiment 1, it is necessary to consider the effect of the flicker upon switching the pattern from the fourteenth half wave of the supplying power duty of 35.7% to the first half wave of the supplying power duty of 42.9% and from the fourteenth half wave of the supplying power duty of 42.9% to the first half wave of the supplying power duty of 35.7%, respectively.

### [Wave Number Control Pattern in the Embodiment 2]

The wave number control pattern in the Embodiment 2 includes a first pattern of which the control period is a first number, which is a number equal to or more than two, of half waves and which satisfies the positive/negative symmetry and a second pattern of which the control period is a second number, which is a number equal to or more than two and divisible by four, of half waves and which satisfies the positive/negative symmetry. Here, in the Embodiment 2, the second number is smaller than the first number. The CPU 32 sets the second pattern in a case in which the supplying power duty is a first duty and sets the first pattern in a case in which the supplying power duty is a second duty which is the adjacent supplying power duty to the first duty, and performs the wave number control. For example, the first duty is the supplying power duty of 33.3%. In the Embodiment 2, hereinafter, it will be described as the second number is twelve (the control period is twelve half waves) and the first number is fourteen (the control period is fourteen half waves). In addition, the second duty is the supplying power duty of 42.9%.

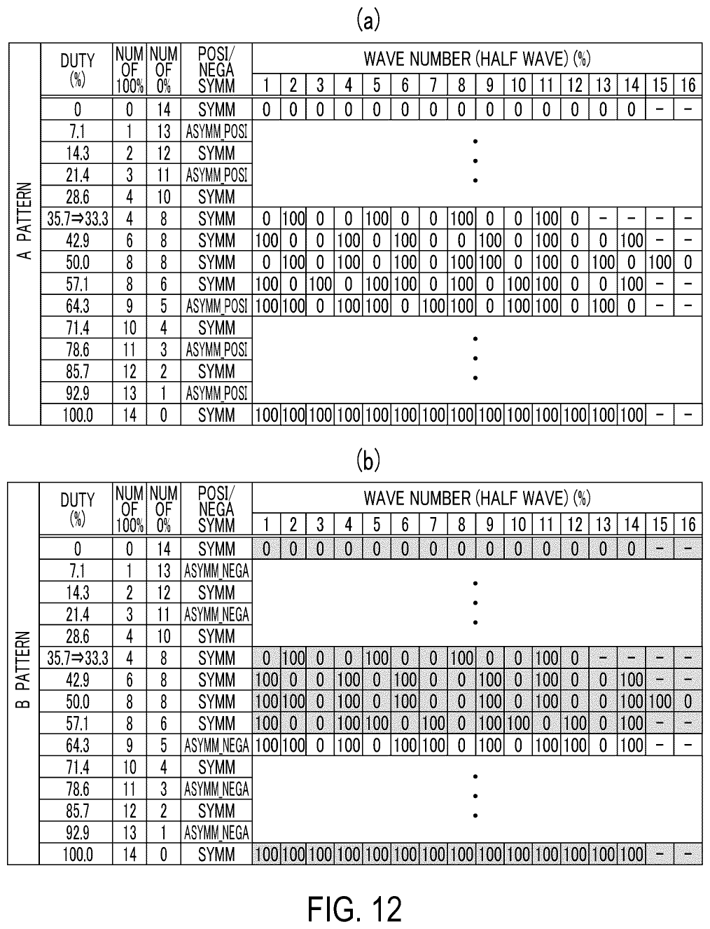

FIG. 12 includes views illustrating the wave number control patterns in the Embodiment 2. Part (a) of FIG. 12 is a view illustrating the supplying power duty of 0% through 100% in the pattern A of the wave number control pattern in the Embodiment 2, and part (b) of FIG. 12 is a view illustrating the supplying power duty of 0% through 100% in the pattern B of the wave number control pattern in the Embodiment 2. Incidentally, in both cases, the supplying power duty of 7.1% through 28.6% and 71.4% through 92.9% are omitted. The information on the supplying power duty of 0% through 100% in the pattern A and the pattern B shown in FIG. 12 is stored in advance in the ROM 32a as the pattern table.

In the pattern A in part (a) of FIG. 12 and in the pattern B in part (b) of FIG. 12, the wave number control pattern of the supplying power duty of 42.9% corresponds to the first pattern described above. In addition, in the pattern A in part (a) of FIG. 12 and in the pattern B in part (b) of FIG. 12, the wave number control pattern of the supplying power duty of 33.3% corresponds to the second pattern described above.

A characteristic portion in the Embodiment 2 is a portion in which the supplying power duty is changed from 35.7% to 33.3%. Originally, the supplying power duty of 35.7% is a pattern in which the half waves of the power supply of 100% are five half waves out of fourteen half waves. By configuring this pattern to a pattern of 33.3% in which the half waves of the power supply of 100% are four half waves out of twelve half waves, it becomes possible to realize a pattern in which the positive/negative symmetry can be satisfied by the twelve half waves. In other words, in the Embodiment 2, it can be said that the wave number length in one control period is shortened from fourteen half waves to twelve half waves. When the supplying power duty is determined to be 33.3%, since the positive/negative symmetry in the twelve half waves can be satisfied by the pattern A, the pattern B can be configured to be the common pattern to the pattern A. Hatched portions in part (b) of FIG. 12 are the half waves in which the power supplies are set to the same as the pattern A.

### [Comparison Between the Embodiment 2 and the Conventional Example]

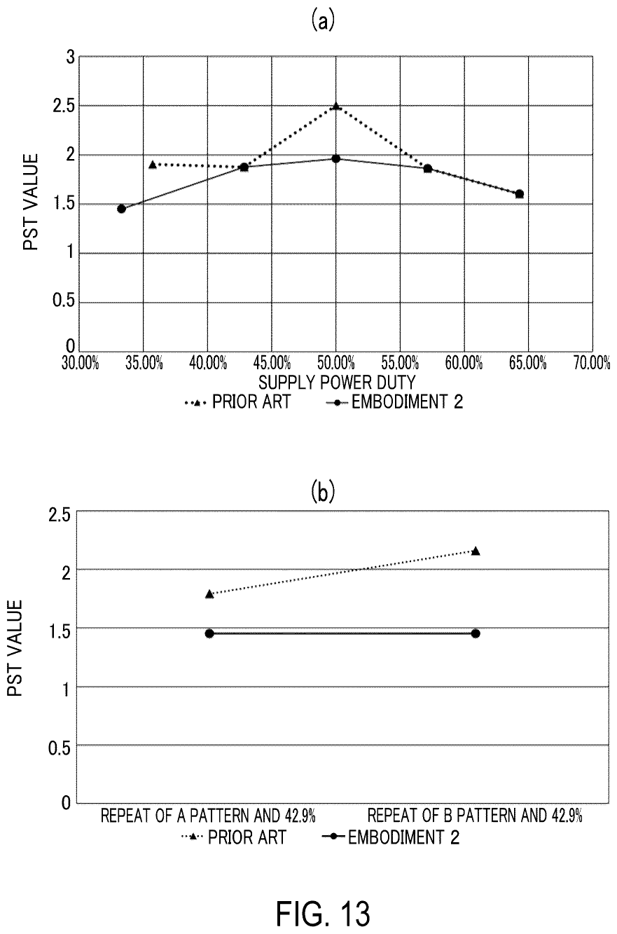

Part (a) of FIG. 13 is a view showing a relationship between the supplying power duty and the Pst values in the Conventional Example and the Embodiment 2. Examining an area near the supplying power duty of 30%, while the supplying power duty is slightly different between the Conventional Example and the Embodiment 2, it can be found that the Pst value can be significantly improved from 1.9 to 1.45. Part (b) of FIG. 13 is a view showing the Pst values upon switching the supplying power duty in the Conventional Example and the Embodiment 2 from around 30% (35.72% in the Conventional Example and 33.3% in the Embodiment 2) to 42.9%. From left of a horizontal axis, a case in which the supplying power duty is switched from 35.72% or 33.3% to 42.9% in the pattern A, and a case in which the supplying power duty is switched from 35.72% or 33.3% to 42.9% in the pattern B are shown. As for the Pst value upon switching the supplying power duty to 42.9%, the Pst value is improved from 2.16 to 1.45 in the pattern B, in which the Pst value is largest.

As described above, by configuring the control period of the supplying power pattern to the control period divisible by 4 to satisfy the positive/negative symmetry, it becomes possible to achieve significant improvement of the flicker even in the cases in which the supplying power duty and the control period of other than 50% are shortened. And it becomes possible to use the heater 102 of which the resistance value is reduced, and increase the suppliable power.

### [Power Supply Control for the Heater]

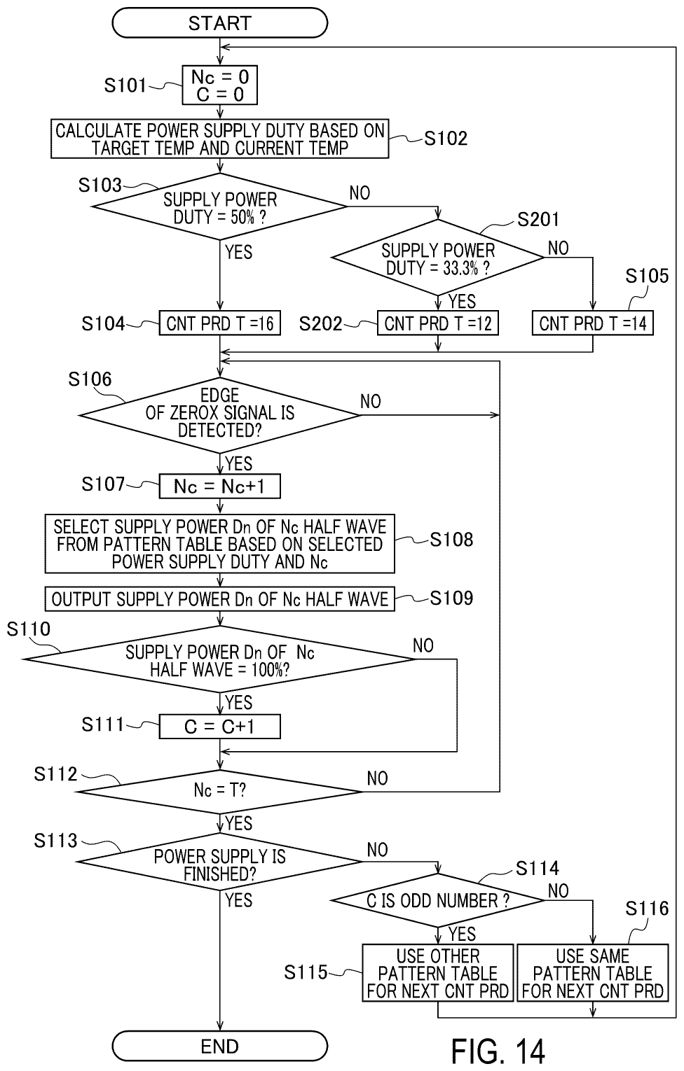

FIG. 14 is a flowchart for describing a power supply sequence in the Embodiment 2. Incidentally, in the flowchart in FIG. 14, to the same process as in FIG. 10, the same step numbers (in 100s) are attached. Hereinafter, the processes of step number in 200s will be mainly described.

In S103, if the CPU 32 determines that the supplying power duty is not 50%, then proceeds the process to S201. In S201, the CPU 32 determines whether or not the supplying power duty is 33.3%. In S201, if the CPU 32 determines that the supplying power duty is 33.3%, then proceeds the process to S202. In S202, the CPU 32 sets the control period T to twelve half waves (T=12) and proceeds the process to S106. In S201, if the CPU 32 determines that the supplying power duty is not 33.3%, then proceeds the process to S105.

Through the above sequence, by configuring the control period of the supplying power duty of 33.3% to the control period of twelve half waves, which can satisfy the positive/negative symmetry, it becomes possible to achieve the significant improvement of the flicker, reduce the resistance value of the heater 102, and increase the suppliable power to the heater 102.

As described above, according to the Embodiment 2, even in the case of reducing the resistance value of the heater in order to increase suppliable power thereto, it becomes possible to improve the flicker in the wave number control.

### Other Embodiments

The present invention may also be realized by a process in which a program realizing one or more functions of the Embodiments described above is supplied to the system or the apparatus via a network or a storage medium, and one or more processors in a computer of the system or the apparatus read out and execute the program. In addition, the present invention may also be realized by a circuit which realizes the one or more functions (e.g., ASIC).

### Embodiment 3

In the Embodiment 1, an example in which the flicker is improved by configuring the control period of the supplying power duty of 50% from fourteen half waves to sixteen half waves, with which the positive/negative symmetry is satisfied, is described. In the Embodiment 2, an example in which the supplying power duty and the control period of other than 50% are shortened is described. In the present Embodiment, an example in which for a DUTY which requires improvement of the flicker, a control period thereof is extended will be described. In the power control for the heater, generally, by setting the control period shorter, it becomes possible to check the target temperature and the actual temperature and reflect it to the supplying power duty in a shorter period, so that it becomes possible to improve controllability in temperature adjustment control and prevent overshoot. Therefore, it is necessary to determine control periods in the supplying power pattern with taking into account the flicker and the controllability due to the control period described so far. In the case of the wave number control, when the control period is short, resolution (number of steps) in the supplying power duty is reduced, so that in the present Embodiment, the control period will be described as eight half waves or more, however, if there is no problem in the controllability and the flicker, it is sufficient for the control period to be two half waves or more and is not limited to the present Embodiment.

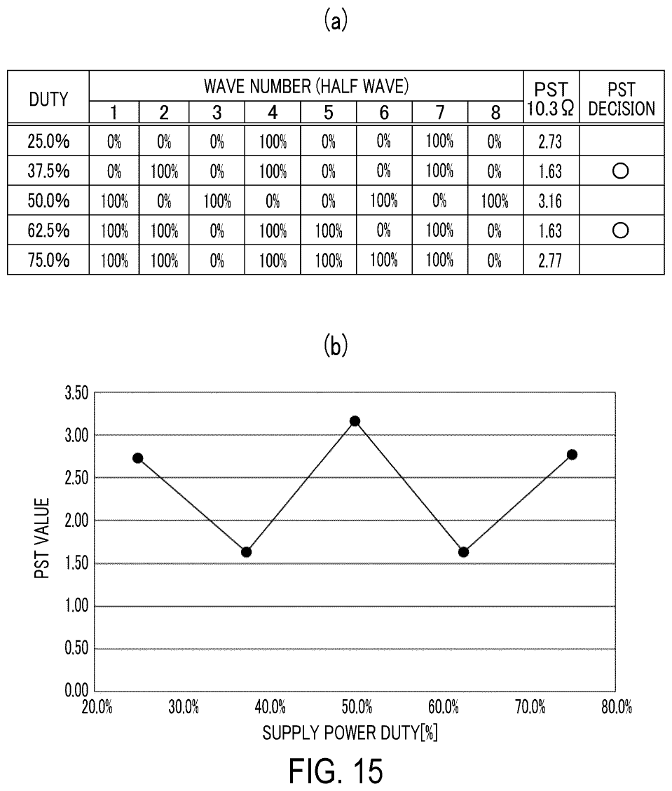

Part (a) of FIG. 15 shows control patterns of which the control period is eight half waves when the supplying power duty is 25%, 37.5%, 50%, 62.5% and 75% in the case of setting the control period to eight half waves in the present Embodiment. Part (b) of FIG. 15 is a view showing the supplying power duty on a horizontal axis and the Pst value on a vertical axis in the case of setting the control period to eight half waves. In the present Embodiment, an allowable Pst value is defined as 2.0, and in the control period of eight half waves, as shown in part (a) and part (b) of FIG. 15, when the supplying power duty is 37.5% and 62.5%, it is possible to obtain the Pst value of 1.63, which is below the allowable Pst value. On the other hand, the Pst values when the supplying power duty is 25%, 50% and 75% are larger than the allowable Pst value. As for the supplying power duty which can satisfy the allowable Pst value in the control period of eight half waves, from the viewpoint of the controllability, the control period is set to eight half waves. In the present Embodiment, as for these supplying power duty which cannot satisfy the allowable Pst value, an example in which the Pst value is improved by extending the control period will be described in detail.

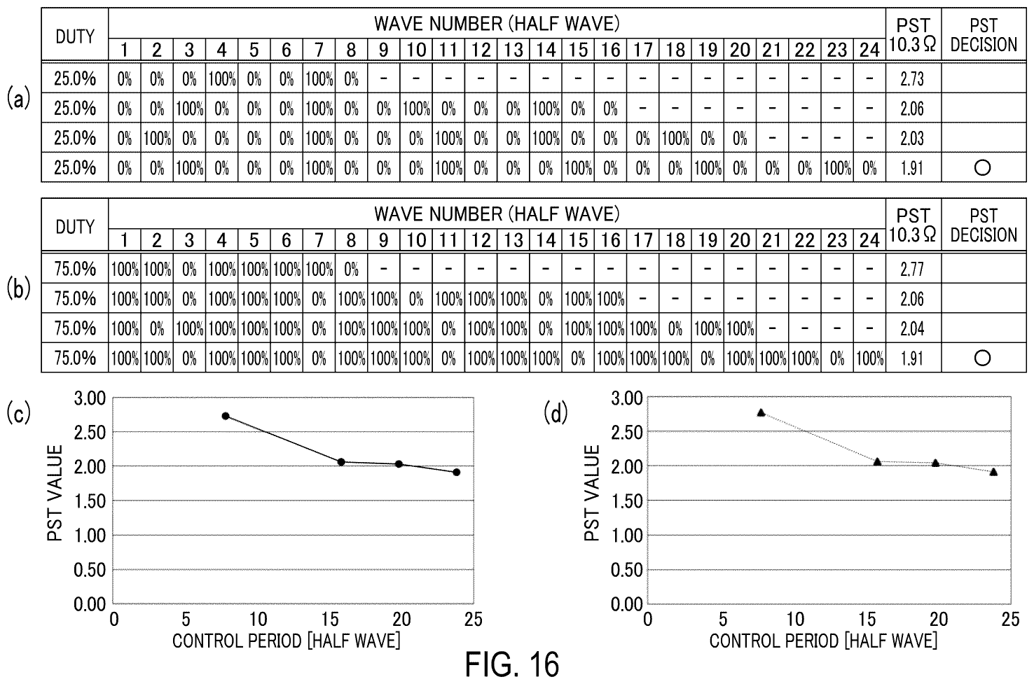

Part (a) of FIG. 16 and part (b) of FIG. 16 are views showing the control patterns of which the control periods are eight half waves, sixteen half waves, twenty half waves and twenty-four half waves in cases in which the supplying power duty is 25% and 75%, respectively. These patterns are control patterns as a result of study to reduce the Pst value for each control period. Part (c) of FIG. 16 and part (d) of FIG. 16 are views showing the Pst values for each control period when the power supply is performed with the control patterns described in part (a) of FIG. 16 and part (b) of FIG. 16. In both cases in which the supplying power duty is 25% and 75%, it can be found that the longer the control period, the better the Pst value. It is possible to make the Pst value for the twenty-four half waves be below the allowable Pst value (2.0) in the present Embodiment.

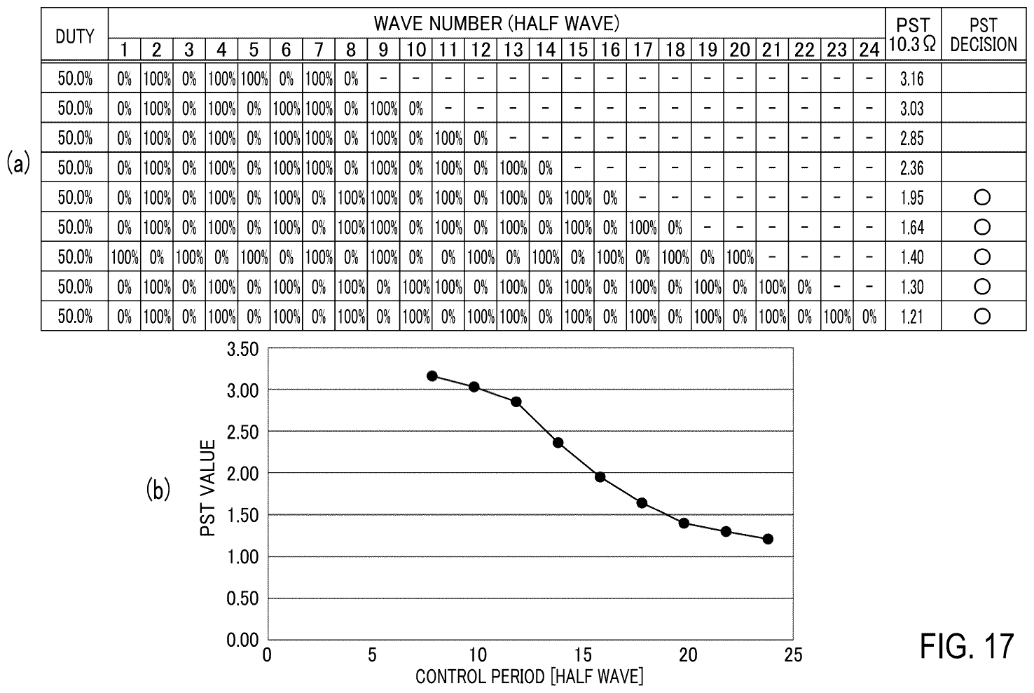

As shown in part (a) of FIG. 16 and part (b) of FIG. 16, the longer the control period, the lower a frequency of the change of the power supply, which causes the flicker, so that the Pst value, which is an evaluation index for the flicker, is also improved. Part (a) of FIG. 17 is a view showing the control patterns of which the control period are eight half waves, ten half waves, twelve half waves, fourteen half waves, sixteen half waves, eighteen half waves, twenty half waves, twenty-two half waves and twenty-four half waves in a case in which the supplying power duty of 50%. These patterns are control patterns as a result of study to reduce the Pst value for each control period. Part (b) of FIG. 17 is a view showing the Pst values for each control period when the power supply is performed with the control pattern described in part (a) of FIG. 17.

As shown in part (b) of FIG. 17, it can be found that the longer the control period, the better the Pst value. The Pst value with the sixteen half waves is 1.95, the Pst value with the eighteen half waves is 1.64, the Pst value with the twenty half waves is 1.40, and the Pst value with the twenty-two half waves is 1.21. As such, with the control periods of equal to or more than sixteen half waves, in any cases, it is possible to make the Pst values be below the allowable Pst value (2.0) in the present Embodiment.

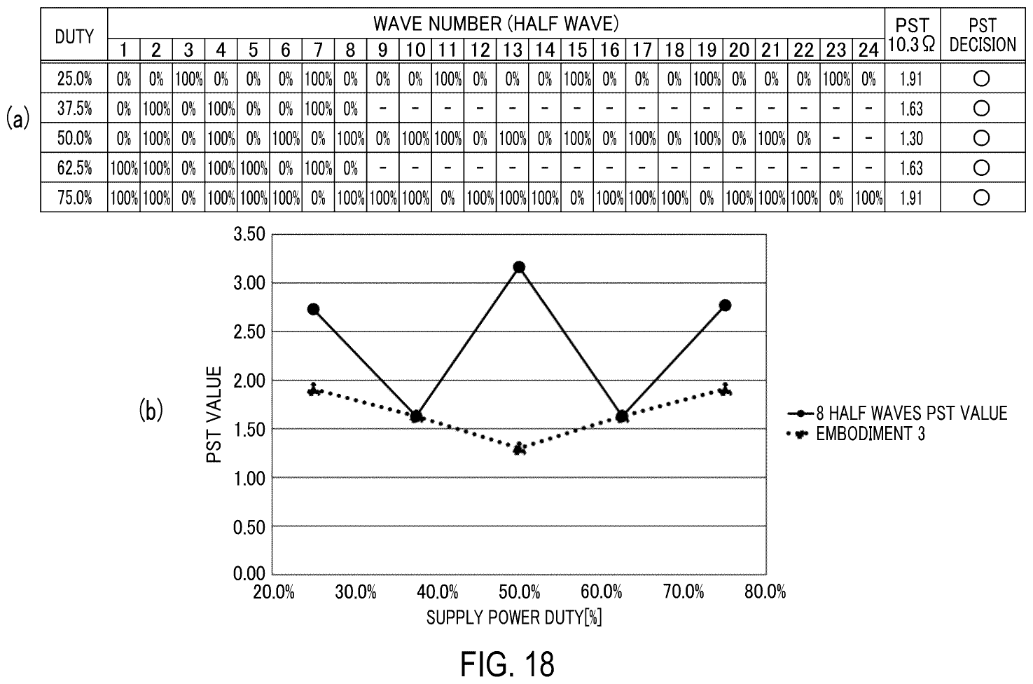

Part (a) of FIG. 18 are control patterns which incorporates the results in which the Pst values are improved by increasing the control period in the cases in which the supplying power duty is 25%, 75% and 50%, which are described so far. The control patterns in part (a) of FIG. 18 are, with respect to the control patterns described in part (a) of FIG. 15, patterns in which the control periods are changed to twenty-four half waves when the supplying power duty is 25% and 75%, and to twenty-two half waves when the supplying power duty is 50%. The shorter the control period, the better the controllability. As described so far, the longer the control period, the better the Pst value and the flicker. For the present control patterns, the control periods are determined for each supplying power duty so that both improvement in the controllability and the Pst value and the flicker can be achieved. In the present Embodiment, the control period is configured to be twenty-two half waves when the supplying power duty is 50%, however, the control period may be shorter than twenty-two half waves as long as the Pst value is below the allowable Pst value, and is not limited to the present Embodiment. By lengthening the control period as necessary for each supplying power duty, it becomes possible, while minimizing deterioration in the controllability, to improve the Pst value and the flicker. Incidentally, all of the Pst values shown in FIG. 15 through FIG. 18 are values when the resistance value of the heater 102 is 10.3Ω. In addition, in Pst judgment, “◯” is assigned to cases in which the Pst value is below the allowable value (2.0).

As described above, according to the Embodiment 3, even in the case of reducing the resistance value of the heater in order to increase suppliable power thereto, it becomes possible to improve the flicker in the wave number control.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2024-160111 filed on Sep. 17, 2024 and 2025-053549 filed on Mar. 27, 2025, which are hereby incorporated by reference herein in their entirety.

What is claimed is:

1. A heating device comprising:
a heat generating member connected to an AC power source;
a switching element connected between the AC power source and the heat generating member, and configured to be switched between a conductive state in which a power of the AC power source is allowed to be supplied to the heat generating member and a non-conductive state in which the power of the AC power source is not allowed to be supplied to the heat generating member;
a control means configured to perform a wave number control in which the power supplied to the heat generating member is controlled by switching the switching element to the conductive state or the non-conductive state for each half wave with a plurality of continuous half waves as a control period in a waveform of an AC voltage of the AC power source; and
a detecting means configured to detect a temperature of the heat generating member,
wherein the control means determines a supplying power duty which is a ratio of the power suppled to the heat generating member in the control period based on the temperature of the heat generating member detected by the detecting means and a target temperature of the heat generating member, sets a power control pattern defining presence/absence of a power supply in each half wave within the control period based on the supplying power duty which is determined, and performs the wave number control in response to the power control pattern which is set,
wherein when a relationship in which a number of positive half waves in which the switching element becomes the conductive state in the control period and a number of negative half waves in which the switching element becomes the conductive state in the control period become the same number is defined as a positive/negative symmetry, the power control pattern includes a first pattern of which the control period is a first number, equal to or more than 2, of half waves and which satisfies the positive/negative symmetry and a second pattern of which the control period is a second number, equal to or more than 2 and divisible by 4, of half waves and which satisfies the positive/negative symmetry, and
wherein the control means sets the second pattern in a case in which the supplying power duty is a first duty and sets the first pattern in a case in which the supplying power duty is a second duty which is the supplying power duty larger by one step or smaller by one step than the first duty, and performs wave number control.

2. The heating device according to claim 1, wherein the first duty is 50%.

3. The heating device according to claim 1, wherein the second number is larger than the first number.

4. The heating device according to claim 1, wherein the first duty is 33.3%.

5. The heating device according to claim 4, wherein the second number is smaller than the first number.

6. The heating device according to claim 1, wherein the power control pattern includes a third pattern of which the control period is the first number of half waves and which does not satisfy the positive/negative symmetry.

7. The heating device according to claim 6, wherein the third pattern includes a fourth pattern of which the number of positive half waves in which the switching element becomes the conductive state is more than the number of negative half waves in which the switching element becomes the conductive state, and a fifth pattern of which the number of negative half waves in which the switching element becomes the conductive state is more than the number of positive half waves in which the switching element becomes the conductive state.

8. The heating device according to claim 7, wherein the control means performs the wave number control with the fifth pattern in a next control period in a case of performing the wave number control with the fourth pattern and performs the wave number control with the fourth pattern in the next control period in a case of performing the wave number control with the fifth pattern.

9. A heating device comprising:
a heat generating member connected to an AC power source;
a switching element connected between the AC power source and the heat generating member, and configured to be switched between a conductive state in which a power of the AC power source is allowed to be supplied to the heat generating member and a non-conductive state in which the power of the AC power source is not allowed to be supplied to the heat generating member;
a control means configured to perform a wave number control in which the power supplied to the heat generating member is controlled by switching the switching element to the conductive state or the non-conductive state for each half wave as a control period of a plurality of continuous in a waveform of an AC voltage of the AC power source; and
a detecting means configured to detect a temperature of the heat generating member,
wherein the control means determines a supplying power duty which is a ratio of the power suppled to the heat generating member in the control period based on the temperature of the heat generating member detected by the detecting means and a target temperature of the heat generating member, sets a power control pattern defining present/absence of a power supply in each half wave within the control period based on the supplying power duty which is determined, and performs the wave number control in response to the power control pattern which is set,
the power control pattern includes a first pattern of which the control period is a first number, equal to or more than 2, of half waves and a second pattern of which the control period is a second number larger than the first number, and
wherein the control means sets the second pattern in a case in which the supplying power duty is a first duty and sets the first pattern in a case in which the supplying power duty is a second duty which is the supplying power duty larger by one step or smaller by one step than the first duty, and performs wave number control.

10. The heating device according to claim 9, wherein when a relationship in which a number of positive half waves in which the switching element becomes the conductive state in the control period and a number of negative half waves in which the switching element becomes the conductive state in the control period become the same number is defined as a positive/negative symmetry,
the first pattern satisfies the positive/negative symmetry.

11. The heating device according to claim 9, wherein when a relationship in which a number of positive half waves in which the switching element becomes the conductive state in the control period and a number of negative half waves in which the switching element becomes the conductive state in the control period become the same number is defined as a positive/negative symmetry,
the second pattern satisfies the positive/negative symmetry.

12. The heating device according to claim 9, wherein the first duty is 50%.

13. The heating device according to claim 10, wherein the power control pattern includes a third pattern of which the control period is the first number of half waves and which does not satisfy the positive/negative symmetry.

14. The heating device according to claim 13, wherein the third pattern includes a fourth pattern of which the number of positive half waves in which the switching element becomes the conductive state is more than the number of negative half waves in which the switching element becomes the conductive state, and a fifth pattern of which the number of negative half waves in which the switching element becomes the conductive state is more than the number of positive half waves in which the switching element becomes the conductive state.

15. The heating device according to claim 14, wherein the control means performs the wave number control with the fifth pattern in a next control period in a case of performing the wave number control with the fourth pattern and performs the wave number control with the fourth pattern in the next control period in a case of performing the wave number control with the fifth pattern.

16. An image forming apparatus for performing image formation on a recording material, the image forming apparatus comprising:
a forming means configured to form a toner image on the recording material; and
a heating device according to claim 1, the heating device heating and fixing the toner image to the recording material.
